(19) United States
(12) Patent Application Publication
(10) Pub. No.: US 2019/0363553 A1
(43) Pub. Date: Nov. 28, 2019

(54) PORTABLE POWER SOURCE

(71) Applicant: Elyse Clark, Newtown, CT (US)

(72) Inventor: Elyse Clark, Newtown, CT (US)

(21) Appl. No.: 16/419,914

(22) Filed: May 22, 2019

Related U.S. Application Data
(60) Provisional application No. 62/674,806, filed on May 22, 2018.

(51) Int. Cl. H02J 7/00; G06F 1/26; H01R 13/72; H01R 13/44; H01R 13/66; H01R 24/28; H01R 31/06

(52) U.S. Cl. CPC H02J 7/0042; G06F 1/26; H02J 7/0063; H01R 13/72; H01R 2103/00; H01R 13/6675; H01R 24/28; H01R 31/065; H02J 2007/0062; H01R 13/44

(57) ABSTRACT

A portable power source includes a housing and an electrical plug for attachment to an external power source. The portable power source also includes a pull-out receptacle having both a female AC power supply and a female USB power supply. The pull-out receptacle is supported by the housing for movement between a storage mode and an extended mode. The portable power source also includes a spring biased retraction mechanism positioned within the housing, The retraction mechanism includes a cord take-up spool electrically connected to the electrical plug via contact rings. An electrical cord connects the pull-out receptacle to the cord take-up spool, wherein electricity runs from through electrical plug, the contact rings, the cord take-up spool and the electrical cord to supply power to the female AC power supply and the female USB power supply.

### BACKGROUND OF THE INVENTION

### 1. Field of the Invention

The invention relates to a portable and compact power source.

### 2. Description of the Related Art

People these days use their portable electronic devices, such as smartphones, laptops and tablets for everything from navigation, shopping, Internet surfing, etc. and constantly need to charge the battery. When the battery needs to be charged people are always looking for convenience and many times while charging people still desire to use their portable electronic devices. People are getting tired of sitting next to a power outlet to use their portable electronic devices while charging it. Airports have even started to install convenient charging stations, as it is common to see people everywhere positioning themselves close to a power outlet to maintain access to their portable electronic devices while their device charges. Many times while the portable electronic device is plugged into a power outlet for charging it is not readily accessible.

The present invention seeks to address the convenience problem and make power readily available via a device that is easily transported with portable electronic devices.

### SUMMARY OF THE INVENTION

It is, therefore, an object of the present invention to provide a portable power source including a housing and an electrical plug for attachment to an external power source. The electric plug is supported by the housing. The portable power source also includes a pull-out receptacle having both a female AC power supply and a female USB power supply. The pull-out receptacle is supported by the housing for movement between a storage mode and an extended mode. The housing includes a receptacle opening formed therein such that a majority of the pull-out receptacle sits therein when the portable power source is in the storage mode. The portable power source also includes a spring biased retraction mechanism positioned within the housing. The retraction mechanism includes a cord take-up spool electrically connected to the electrical plug via contact rings. An electrical cord connects the pull-out receptacle to the cord take-up spool, wherein electricity runs from through electrical plug, the contact rings, the cord take-up spool and the electrical cord to supply power to the female AC power supply and the female USB power supply.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a top perspective view of the portable power source of the present invention.

FIG. 2 is a side perspective view of the portable power source of the present invention.

FIG. 3 is a side view of the portable power source of the present invention.

FIG. 4 is an exploded view of the portable power source of the present invention.

FIG. 5 is a front perspective view of the portable power source of the present invention.

FIG. 6 is an end view of the portable power source of the present invention.

FIG. 7A is a front perspective view of the portable power source of the present invention plugged into an electrical outlet.

FIG. 7B is a front view of a conventional electrical outlet.

FIG. 8 is a front perspective view of the portable power source of the present invention with the cord partially extended.

FIG. 9 is a side perspective view of the portable power source of the present invention.

FIG. 10 is a bottom perspective view of the portable power source of the present invention with the bottom plate removed.

FIG. 11 is a perspective view of the pull-out receptacle with the back panel removed.

FIG. 12 is a view of the inside of the spool.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

Referring now to the drawings, a portable power source 10 is disclosed. While plenty of cubes, strips and bars are known for providing remote power, the present portable power source 10 offers functionality and structure obviating limitations of the prior art so as to provide a portable power source 10 that offers a compact power source assembly for use in conjunction with both AC powered and USB powered devices.

The portable power source 10 includes a housing 12 supporting an electrical plug 40 for attachment to an external power source in the form of a conventional electrical outlet 100. The housing 12 also supports a pull-out receptacle 14 having a housing 14h which can be extended and retracted for compact use and storage. The pull-out receptacle 14 includes both a female AC power supply 14b and a female USB power supply 14a contained within the housing 14h. The female power supply 14b and the female USB power supply 14a are respectively constructed for attachment to male plugs of AC powered devices and male plugs of USB powered devices. An insulation plate 14p separates the female USB power supply 14a from the female AC power supply 14b. The insulating plate 14p is attached to the housing 14h by screws 14s and functions to maintain the female AC power supply 14b in proper position. The pull-out receptacle 14 also includes opposed finger grip recesses 15 to assist with gripping thereof when it is pulled from the housing 12. The electronics (not known) to convert AC power into standard USB voltage are self-contained within housing 14h and are well known to those skilled in the art.

The housing 12 is substantially rectangular in shape and includes a base 20, a top plate 16 having a top surface 16t and a bottom plate 18 having a bottom surface 18b. The top plate 16 and bottom plate 18 are preferably attached to the base 20 via screws 34. However, other means of attachment such as adhesive are contemplated. When assembled, the housing 12 includes a plurality of sidewalls 20a-d (for example, first, second, third, and fourth sidewalls 20a-d), which are the outer walls of the base 20, extending between the top surface 16t and the bottom surface 18b. In accordance with a disclosed embodiment, both the top surface 16t and the bottom surface 18b are square-shaped when viewed from above and include respective first, second, third, fourth edges 16a-d, 18a-d. The first, second, third, and fourth edges 16a-d, 18a-d of the top plate 16 and the bottom plate 18 are respectfully connected by the first sidewall 20a, the second sidewall 20b, the third sidewall 20c, and the fourth sidewall 20d.

In accordance with a preferred embodiment, the second sidewall 20b and the third sidewall 20c define substantial flat, uninterrupted surfaces. The first sidewall 20a includes a release button opening 21 in the form of cavity with opposed sidewalls and a rear wall for supporting a release button 68. The fourth sidewall 20d includes a receptacle opening 22 in the form of cavity with opposed sidewalls and a rear wall for supporting the pull-out receptacle 14. The receptacle opening 22 is shaped and dimensioned for receiving the pull-out receptacle 14. With this in mind, the rear wall of the receptacle opening 22 includes an aperture 26 which is shaped and dimensioned for the passage of the electrical cord 28 connecting the pull-out receptacle 14 to the retraction mechanism 30 and, in turn, the electrical plug 40.

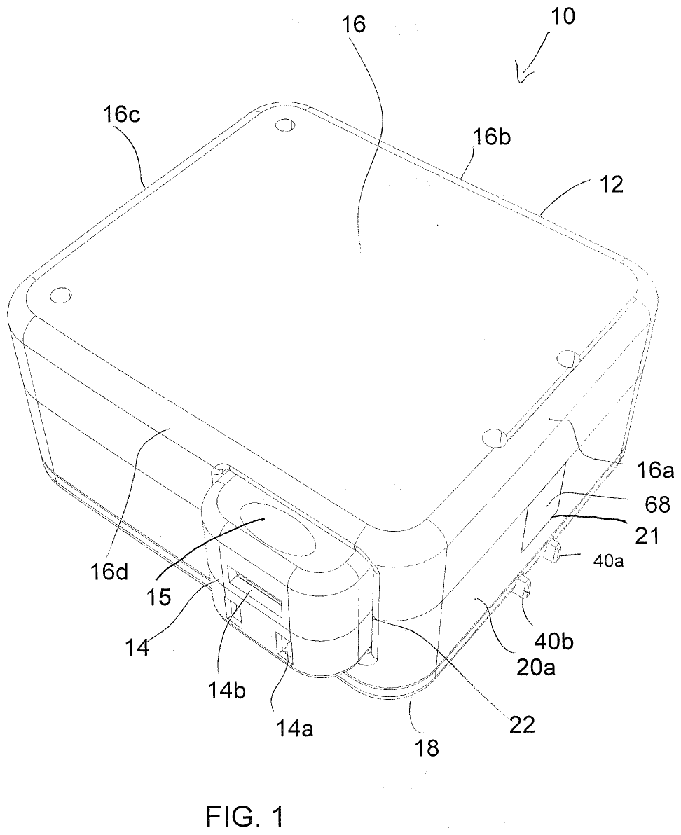

In particular, and as will be appreciated based upon the following disclosure, the receptacle opening 22 formed in the fourth sidewall 20d is shaped and dimensioned such that the majority of the pull-out receptacle 14 can sit therein when the portable power source 10 is in its storage mode as shown with reference to FIG. 1. However, a small portion of the pull-out receptacle 14 extends beyond the receptacle opening 22 such that it maybe gripped via the opposed finger grip recesses 15 by a user desiring to extend the pull-out receptacle 14 from the housing 12 for use.

As mentioned above, the pull-out receptacle 14 includes an electrical cord 28 which is secured to both a retraction mechanism 30 and, in turn, the electrical plug 40 which connects to an external power source as further explained below. The electrical cord 28 is supported by the retraction mechanism 30 such that the electrical cord 28 may be selectively pulled from the housing 12 to allow for selective extension of the pull-out receptacle 14 from the housing 12 for use by those in need of a power source.

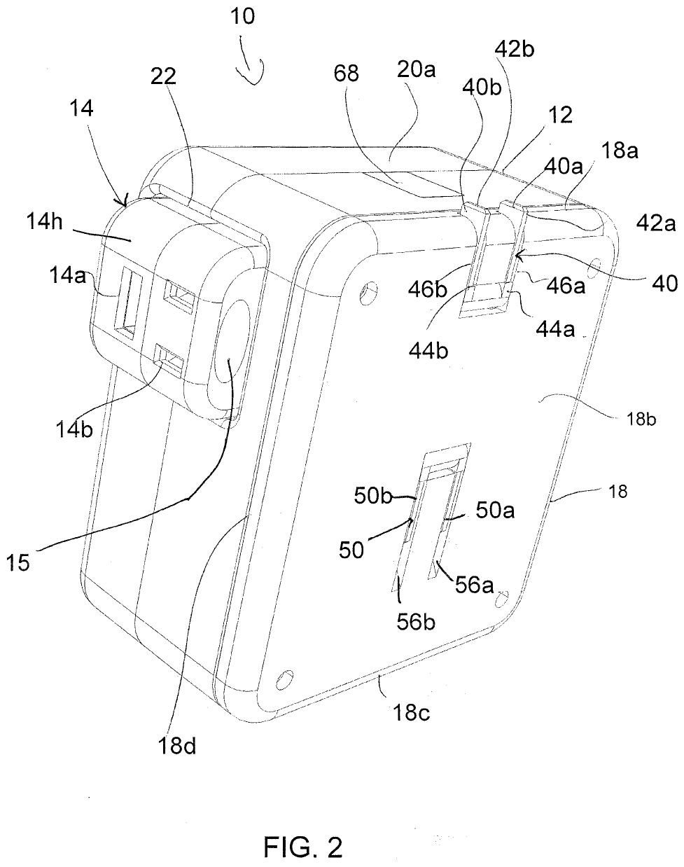

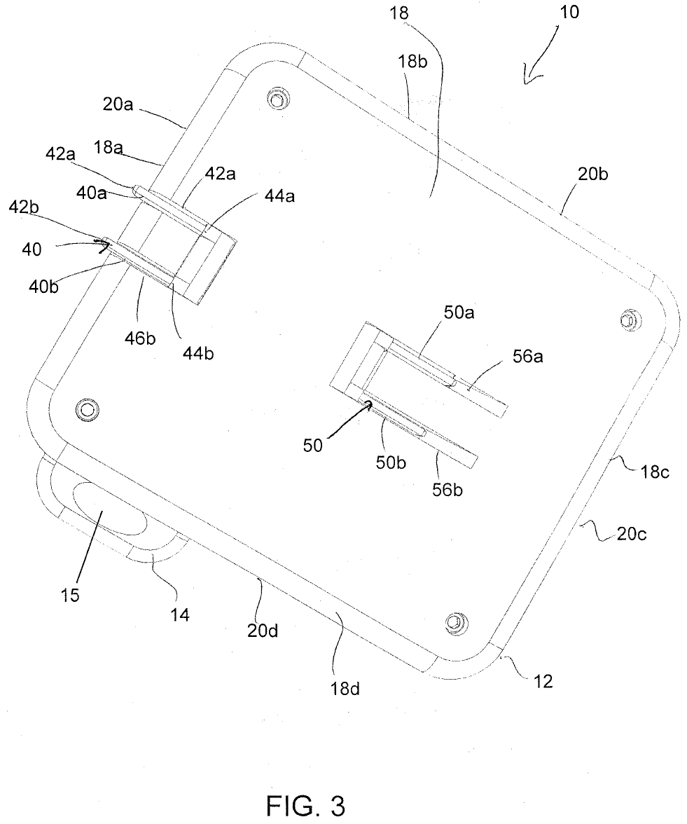

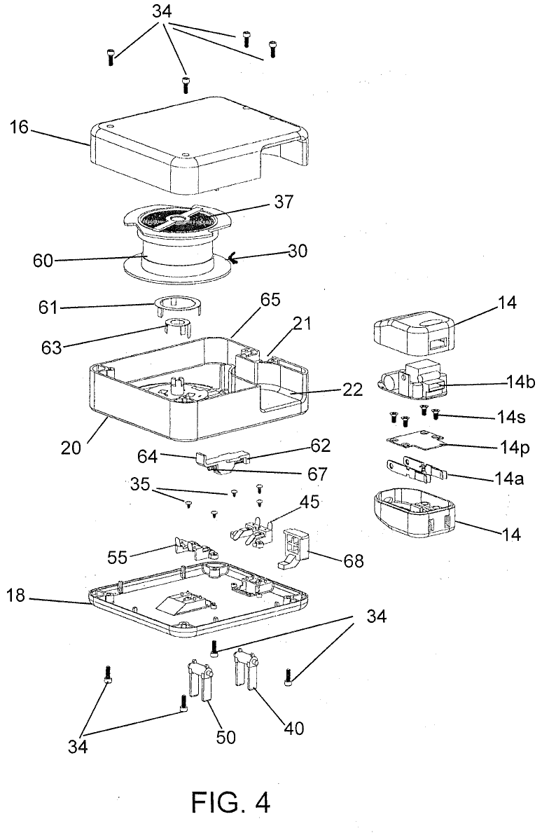

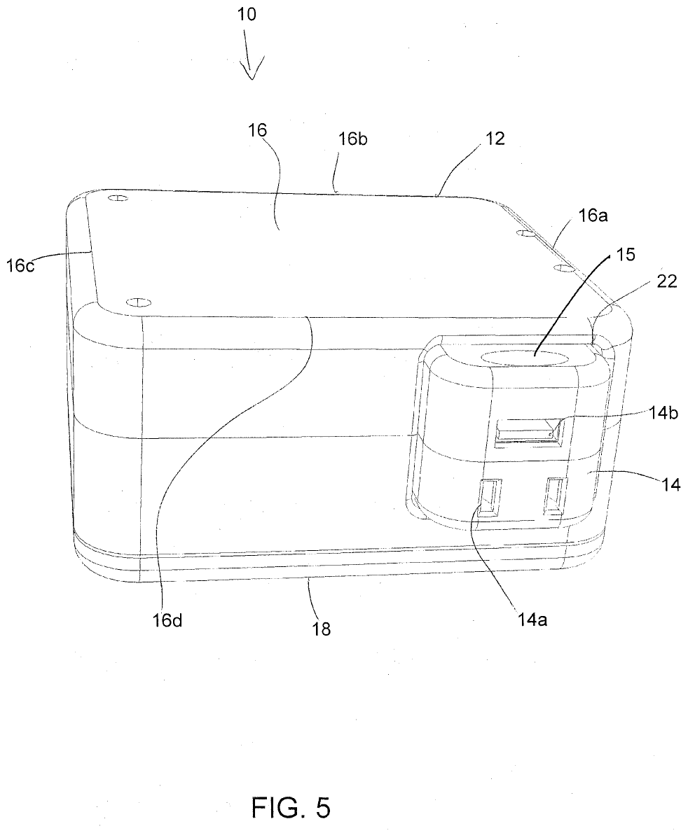

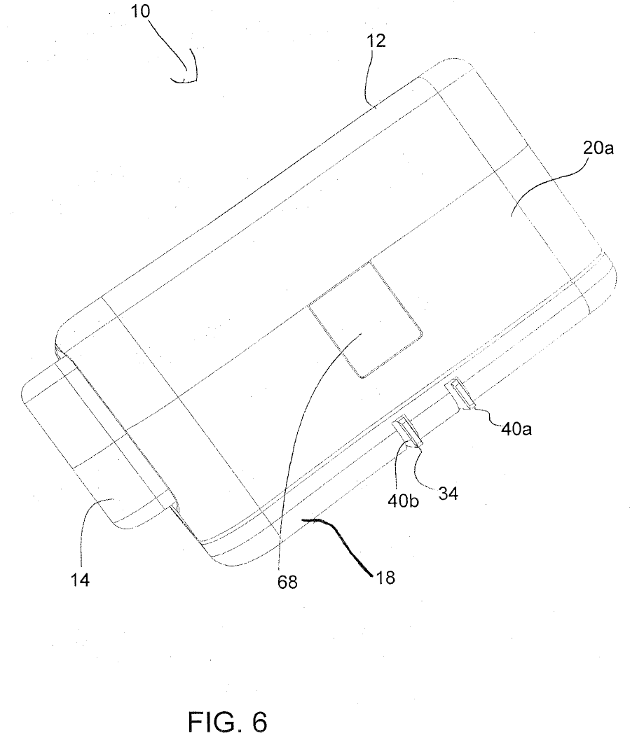

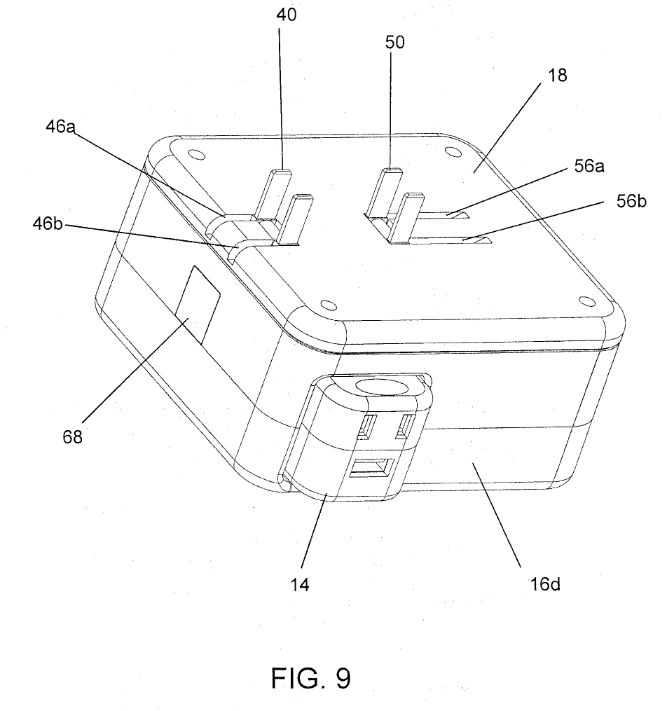

Considering first the electric plug 40 used for attachment of the present portable power source 10 to the external power source, the electric plug 40 is mounted along the bottom surface 18b of the bottom plate 18 of the housing 12 in a manner allowing for selective movement between a recessed first orientation shown in FIG. 2 and an extended second orientation, which is 90 degrees from the recessed orientation shown in FIG. 9. The electric plug 40 includes standard first and second leg members 40a, 40b that are shaped and dimensioned for insertion within a conventional electric electrical outlet 100 found within a wall or other structure. The first and second leg members 40a, 40b include first ends 42a, 42b that are adapted for insertion within a female receptacle 102 of the conventional electric electrical outlet 100 while the second ends 44a, 44b of the first and second leg members 40a, 40b are pivotally secured to the bottom plate 18 of the housing 12. As such, the first and second leg members 40a, 40b are adapted for rotational movement between their recessed first orientation and their extended second orientation. When in their extended second orientation the rear of leg members 40a, 40b make contact with a contact 45 contained within the housing 12 thereby completing the electrical circuit from the external power source to the pull-out receptacle 14. The contact 45 is secured to bottom plate 18 via screws 35. Proper recessing of the first and second leg members 40a, 40b is facilitated by the provision of first and second recesses 46a, 46b formed within the bottom surface 18b. In this way, and when the first and second leg members 40a, 40b are in their recessed first orientation, the first and second leg members 40a, 40b are hidden within the first and second recesses 46a, 46b and the bottom surface 18b remains substantially flat. Access to the first and second leg members 40a, 40b is facilitated by positioning them along the first edge 18a of the bottom surface 18b such that when the first and second leg members 40a, 40b are in their recessed first orientation they extend slightly beyond the first sidewall 20a and the first edge 18a of the bottom surface 18b. In this way, a user can engage the first ends 42a, 42b of the first and second leg members 40a, 40b and rotate them to their extended second orientation 90 degrees from their recessed position.

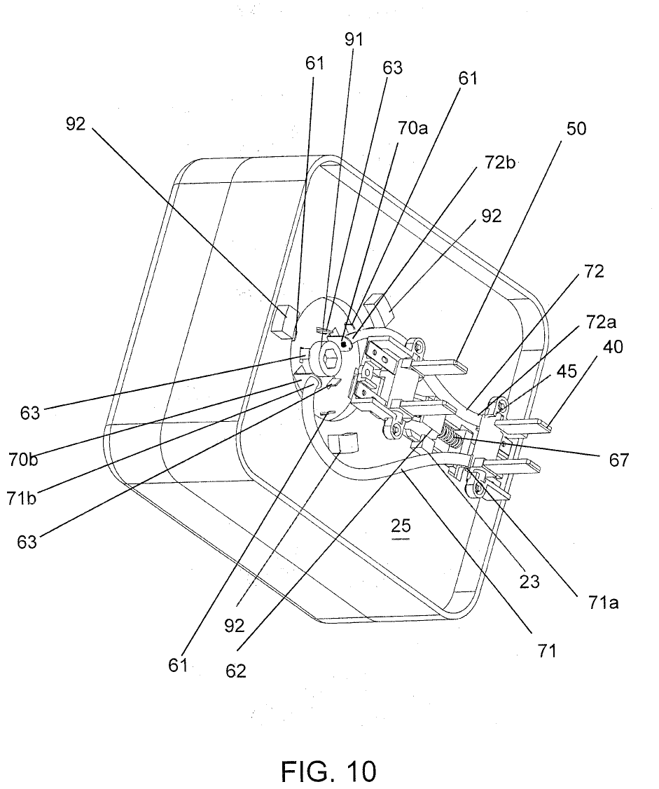

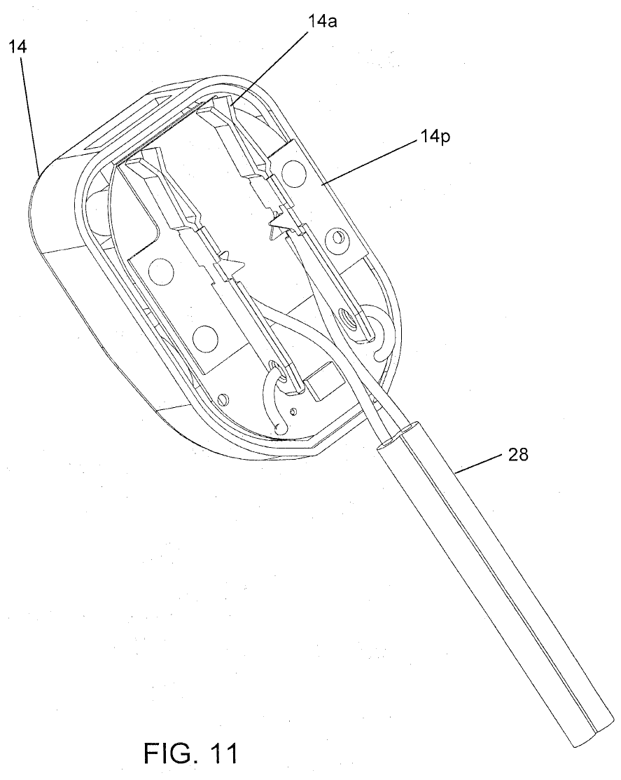

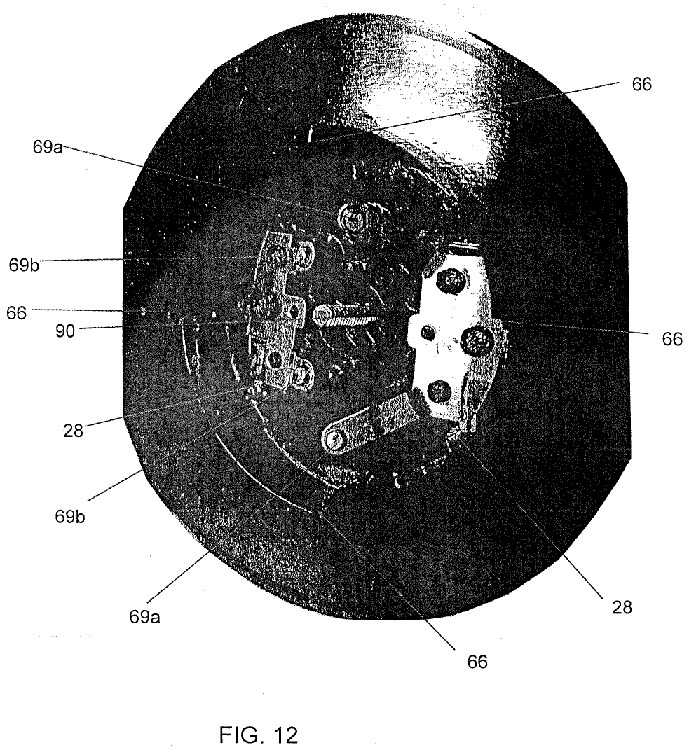

As best viewed in FIG. 10, the electric plug 40 is in its extended second orientation and in electrical contact with contact 45, which is attached to first and second wires 71, 72 at their first wire ends 71a, 72a, respectively. The opposite second end 71b of the first wire 71 is attached to the second prong 70b and the opposite second end 72b of the second wire 72 is attached to the first prong 70a. The first prong 70a is in electrical contact with an outer contact ring 61 and the second prong 70b is in electrical contact with an inner contact ring 63. As shown in FIG. 12, the inside of a cord take-up spool 60 of the retraction mechanism 30 is hollow and includes a first set of spring contacts 69a and a second set of spring contacts 69b. The first set of spring contacts 69a engages and rides on the outer contact ring 61 while the cord take-up spool 60 is stationary or rotating and the second set of spring contacts 69b engages and rides on the inner contact ring 63 while the cord take-up spool 60 is stationary or rotating. The first and second sets of spring contacts 69a, 69b are respectively connected to the “Neutral” and “Hot” lines of the electrical cord 28, completing the electrical circuit from electric plug 40 to pull-out receptacle 14.

Also shown in FIG. 12 is a bolt 90 which runs through the cord take-up spool 60 and attaches to a nut 91 shown in FIG. 10, thus securing the cord take-up spool 60 to the base 20 for rotation therein. The base 20 includes blocks 92 which add strength thereto in the area in which the cord take-up spool 60 rotates.

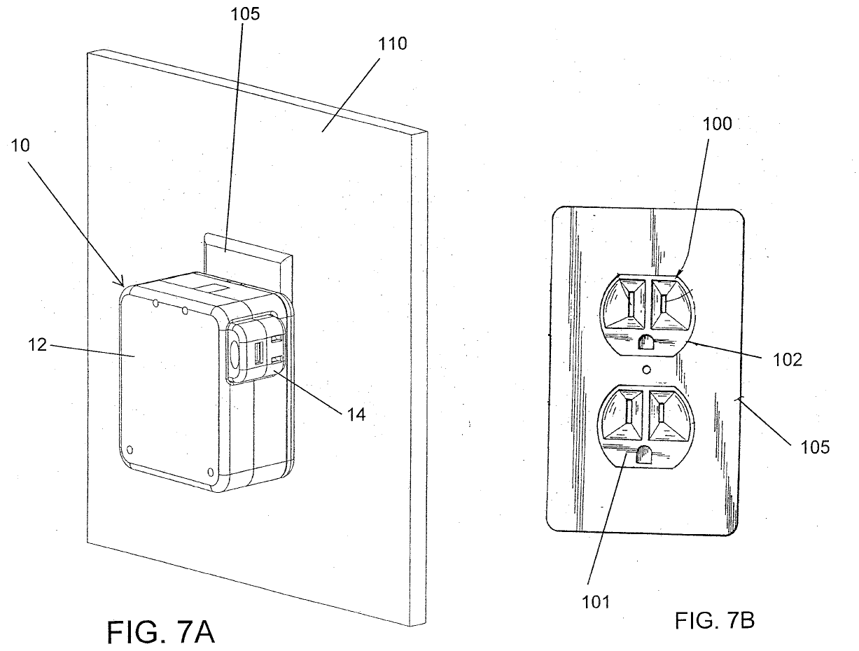

Secure mounting of the housing 12 to an electrical outlet 100 is further facilitated by the provision of a mounting prong 50 composed of first and second mounting prong leg members 50a, 50b. Note FIGS. 7A and 7B, which show the portable power source 10 plugged into the electrical outlet 100 and an electrical outlet 100 with nothing attached, respectively. The electrical outlet 100 is mounted in a wall 110 and covered by a cover plate 105. The electrical outlet 100 includes adjacent female receptacles 101, 102. The first and second mounting prong leg members 50a, 50b are positioned such that they may be positioned within an electrical outlet 100 in the female receptacle 101 adjacent to the female receptacle 102 in which the electric plug 40 is positioned. As those skilled in the art will appreciate, conventional electrical outlets 100 are formed with first and second female receptacles 101, 102 such that two electrical devices maybe secured thereto at the same time. The first female receptacle 101 is utilized by the present portable power source 10 so as to provide stability and a secure attachment for the housing 12. In order to ensure that the mounting prong 50 does not cause any problems with regard to the conduction of electricity, it may be formed from a nonconductive material, preferably a hard plastic material. The mounting prong 50 makes contact with nonconductive contact 55 when in its extended second orientation, similar to the electric plug 40. The contact 55 is not electrically connected to anything in the portable power source 10 and is secured to the bottom plate 18 via screws 35.

In addition, and as with the first and second leg members 40a, 40b, the first and second mounting prong leg members 50a, 50b are pivotally secured to the housing 12 for movement between a recessed first orientation and an extended second orientation, which is 90 degrees from the recessed orientation as shown in FIGS. 9 and 10. Proper recessing of the first and second mounting prong leg members 50a, 50b is facilitated by the provision of recesses 56a, 56b within the bottom surface 18b of the bottom plate 18 of the housing 12. The recesses 56a, 56b are shaped and dimensioned to receive the first and second mounting prong leg members 50a, 50b when they are in the first recessed orientation. It appreciated the positioning of the first and second leg members 40a, 40b and the first and second mounting prong leg members 50a, 50b along the bottom surface 18b may be varied depending upon various needs and concerns of the end user.

In practice, the first and second leg members 40a, 40b, as well as the first and second mounting prong leg members 50a, 50b are first extended outwardly, that is, rotated to their extended second orientations. With the first and second leg members 40a, 40b and the first and second mounting prong leg members 50a, 50b extended outwardly, the first and second plug members 40a, 40b are inserted within the top second female receptacle 102 of the electrical outlet 100 and the first and second mounting prong leg members 50a, 50b are inserted within the lower first female receptacle 101 of the electrical outlet 100. In this way, a great deal of support is provided as the housing 12 sits along the electrical outlet 100 adjacent to a wall.

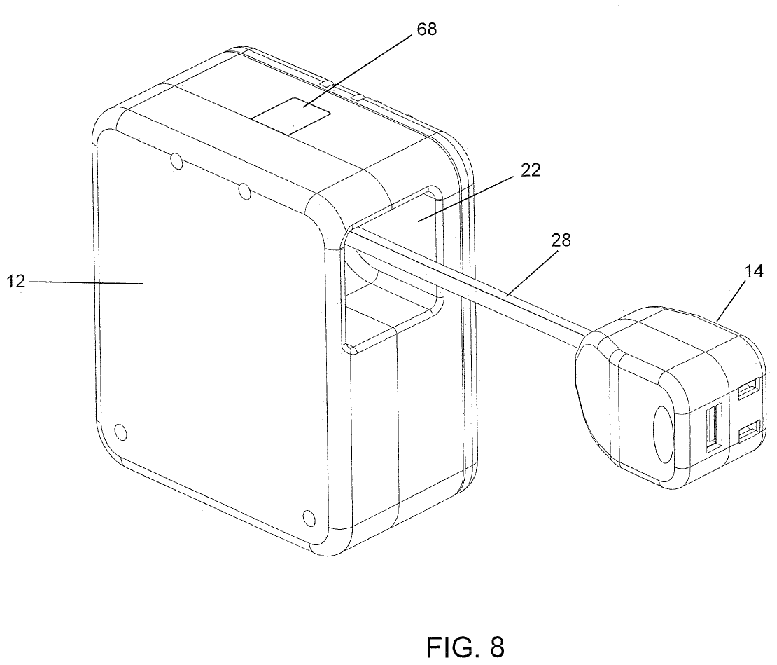

The present portable power source 10 includes a retraction mechanism 30 allowing for extension and retraction of the electrical cord 28, and ultimately the pull-out receptacle 14 secured to the electrical cord 28. The cord 28 is shown partially extended in FIG. 8 and fully retracted in FIG. 9. As previously mentioned, the retraction mechanism 30 includes a cord take-up spool 60 about which the electrical cord 28 is wrapped. The cord take-up spool 60 is spring biased for rotation by a spring 37 so as to continuously pull the electrical cord 28 to its retracted orientation (which in accordance with a disclosed embodiment is counterclockwise, although it could be in either direction depending upon manufacturing and use considerations), that is, its orientation when the electrical cord 28 is wrapped about the cord take-up spool 60 and the pull-out receptacle 14 is within the recess 22. Control mechanisms for such retractable cord spools are well known in the art and various retraction mechanisms maybe utilized within the spirit of the present invention.

In accordance with a disclosed embodiment, a spring-loaded release mechanism 62 is mounted within the housing 12. The spring-loaded mechanism 62 is mounted to the bottom surface 25 of the base 20 via clips 23 molded into the base 20, as seen in FIG. 10. The spring-loaded release mechanism 62 includes a pawl 64 that is oriented to engage four spaced ratchets 66 formed along the cord take-up spool 60 for permitting selective retraction and extension of the electrical cord 28 attached thereto and a spring 67 which pushes the pawl 64 into engagement with the spool 60. In particular, and as the pull-out receptacle 14 is pulled away from the fourth sidewall 21d and the electrical cord 28 is withdrawn from the housing 12, the cord take-up spool 60 rotates in a clockwise direction against the spring bias of the cord take-up spool 60. The pawl 64 of the release mechanism 62 moves over the ratchets 66 formed along the exterior surface of the cord take-up spool 60 and allow clockwise rotation of the cord take-up spool 60 as the electrical cord 28 and pull-out receptacle 14 are pulled outwardly away from the housing 12. When the electrical cord 28 reaches its desired length of extension, and tension is no longer being applied to the electrical cord 28, the spring bias of the cord take-up spool 60 makes the cord take-up spool 60 attempt to move in a counterclockwise direction, and the pawl 64 of the release mechanism 62 engages one of the ratchets 66 of the cord take-up spool 60 preventing movement of the cord take-up spool 60 in the counterclockwise direction that would result in retraction of the electrical cord 28. When it is desired to retract the electrical cord 28, the release button 68 secured to the release mechanism 62 is simply pressed inwardly, causing the pawl 64 to disengage from the ratchets 66 and allowing the spring bias of the cord take-up spool 60 to rotate in such a way that the electrical cord 28 is wrapped around the cord take-up spool 60 and the pull-out receptacle 14 is pulled into the receptacle opening 22 formed within the housing 12. The release button 68 is conveniently mounted along the first sidewall 20a for ready access by a user of the portable power source 10.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by appended claims. For example, it is contemplated that instead of the pull-out receptacle 14 being pulled out from the housing 12 of the portable power source 10, an electrical plug similar to plug 40 could be pulled out from a housing of a portable power source and the housing would have power receptacles formed therein.

1. A portable power source, comprising:
a housing;
an electrical plug for attachment to an external power source, the electric plug being supported by the housing;
a pull-out receptacle including both a female AC power supply and a female USB power supply, the pull-out receptacle supported by the housing for movement between a storage mode and an extended mode, wherein the housing includes a receptacle opening formed therein such that a majority of the pull-out receptacle sits therein when the portable power source is in the storage mode;
a spring biased retraction mechanism positioned within the housing, the retraction mechanism including a cord take-up spool electrically connected to the electrical plug via contact rings;
an electrical cord connecting the pull-out receptacle to the cord take-up spool, wherein electricity runs through the electrical plug, the contact rings, the cord take-up spool and the electrical cord to supply power to the female AC power supply and the female USB power supply.
